(19) United States
(12) Patent Application Publication
(10) Pub. No.: US 2019/0129191 A1
(43) Pub. Date: May 2, 2019

(54) Lenticular 3D Display

(71) Applicant: Jing Zhang, Manhattan Beach, CA (US)

(72) Inventor: Jing Zhang, Manhattan Beach, CA (US)

(21) Appl. No.: 15/800,351

(22) Filed: Nov. 1, 2017

(51) Int. Cl. G02B 27/22; G02B 3/00; G02B 27/02

(52) U.S. Cl. CPC G02B 27/2214; G02B 27/024; G02B 3/0075

(57) ABSTRACT

A lenticular 3D display which can display 3D effect image is provided. The lenticular 3D display comprises a frame, a lenticular sheet, a replaceable image sheet, and a supporting board. The supporting board has a arched surface to push the image sheet to attached to the lenticular sheet tightly to achieve a better alignment and better 3D effect. The replaceable image sheet can be printed with regular media and printers.

### BACKGROUND

### 1. Field of the Invention

The present invention relates to a lenticular 3D display. More particularly, the 3D display has a fixed lenticular lens and uses a replaceable lenticular image.

### 2. Discussion of the Related Art

Lenticular lens can provide a 3D effect with a 2D printing. The lenticular lens has a series of cylindrical lenses. Because of the refraction, the cylindrical lens can focus the sight on different area, so two eyes will see different slices under each cylindrical lens. Therefore, by slicing two or more images and arranging them alternatively under the lenticular lenses, two eyes can simultaneously see two images. This can generate an illusion of depth, or 3D effect.

Typically a lenticular display or light box utilizes a lenticular sheet which is a translucent plastic sheet with a set of small cylindrical lenses on the front side and a flat surface on the back side. Then the lenticular image can be printed on the back side of the lenticular sheet directly. The printing should be accurately aligned with the lenses. Alternatively the image can be printed on a printing substrate and bonded to the back of the lenticular sheet.

In order to realize 3D effect by lenticular in a light box, several facts should be considered. First is the viewing angle. For 3D image, the viewing angle usually is less than 30°. To achieve a narrower viewing angle, the lenticular sheet should be thicker.

Then is the density of lenses. It is usually defined by LPI (lens per inch). Typically, as the size of the image increases, the LPI of the lenticular sheet will decrease, and the thickness of the lenticular sheet should be increased in consequence. Also the larger the image size, the more difficult it becomes to properly align the lens with the image.

The viewing distance should also be considered. The viewing distance is inversely proportional to the LPI of the lenticular lens. A longer viewing distance will typically require a lower LPI.

Therefore, in order to display a lenticular 3D image with a larger size and a longer viewing distance, which is important for advertisement, the lenticular sheet should have smaller LPI and larger thickness, also the image should be aligned accurately.

But there are some disadvantages of the current technique. First, only special printing presses can print on the thick and unbending lenticular sheet. Most printers can't print on the lenticular sheet directly. This will increase the cost and limit the application. Second, the alignment is important and will take more effort. Third, the lenticular sheet can't be reused because the lenticular image is permanently printed or attached on it. Sometimes, in order to reused the lenticular sheet, the image is printed or fixed on a flat substrate, and the lenticular sheet is placed over the image. This will solve those problems but since the lenticular sheet is soft and flexible, in some area the image and the lenticular sheet can't attached together tightly. But even a tiny gap will make the image and lenses misaligned, and cause the 3D image deformed. This deformation is easier to happen and more obvious for larger size of the image.

Considering all these disadvantages mentioned above, it would be desirable to provide an apparatus which is more efficient to use.

### BRIEF SUMMARY OF THE INVENTION

The primary objective of the present invention is to develop a lenticular 3D display can be reused by replacing the image.

Another object of the present invention is to develop a lenticular 3D display with low cost.

The invention comprises the following, in whole or part:

A frame, a lenticular sheet, a replaceable image sheet, and a supporting board. The supporting board has a arched surface to push the image sheet to attached to the lenticular sheet tightly to achieve a better alignment and better 3D effect.

For a more complete understanding of the present invention with its objectives and distinctive features and advantages, reference is now made to the following specification and to the accompanying drawings.

### BRIEF DESCRIPTION OF THE DRAWING(S)

FIG. 1 is a top view of a lenticular 3D display according to an embodiment of the invention.

FIG. 2 is a perspective view of a lenticular 3D display illustrating the bottom of the embodiment of the invention.

FIG. 3 is a perspective view illustrating a lenticular 3D display when it is opened.

FIG. 4 is a schematic sectional view of a lenticular 3D display.

### DETAILED DESCRIPTION OF THE INVENTION

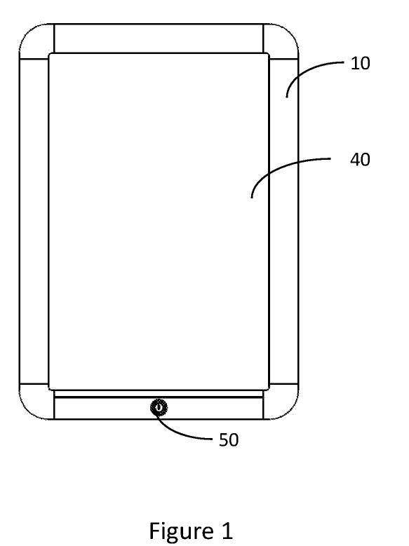

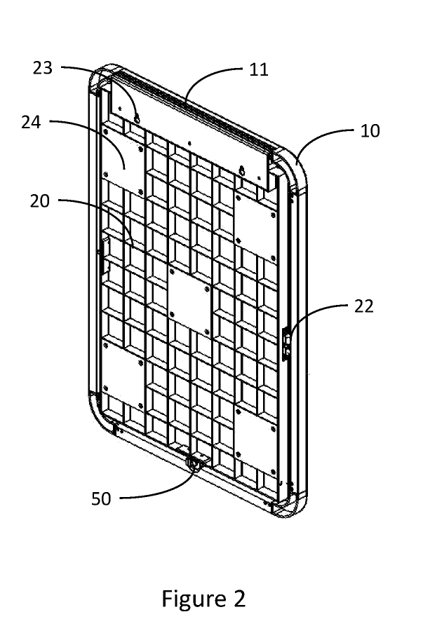

In accordance with a preferred embodiment, FIGS. 1 to 4 depict the lenticular 3D display as a preferred embodiment of the present invention. Referring to FIGS. 1 and 2, the lenticular 3D display of the present invention comprises a frame 10, a supporting board 20, an image sheet 30, and a lenticular sheet 40.

The lenticular sheet 40 is a translucent sheet. It has a top side with an arrange of lenses on it, and a bottom side with a flat surface. Preferably, the lenses are cylindrical lenses aligned vertically. The lenticular sheet 40 has a set of predetermined characteristics such as LIP, thickness, and shape of the lenses according to the application of the 3D display. The lenticular sheet 40 can be formed in one piece, or by attaching a lens membrane on a translucent substrate.

The lenticular sheet 40 is received in the frame 10 with the front side exposed. The lenticular sheet 40 is fixed in the frame 10, or alternatively is detachable for replacing different type of lenticular sheets for different applications. The frame 10 may also comprises a transparent screen to cover the front side of the lenticular sheet 40 for protection.

The image sheet 30 is a piece of printing media with lenticular image printed on it. The lenticular image is designed in accordance with the characteristics of the lenticular sheet 40 for achieving a desired effect, such as 3D effect, flip, or animation. The printing media could be paper, film, plastic sheet, etc. as long as the lenticular image can be printed on it with required resolution. As a result, most printers can be used to print the lenticular image.

The supporting board 20 is a substrate having a top surface. The image sheet 30 can be removably held on the top surface. The supporting board 20 may comprise a fasten feature to fasten the image sheet 30, such as one of more clips. The supporting board 20 may also comprise alignment feature to align the image film in correct position, such as protruded lines or edges to regulate the position of the image sheet 30. Therefore the image sheet 30 can be easily replaced and aligned.

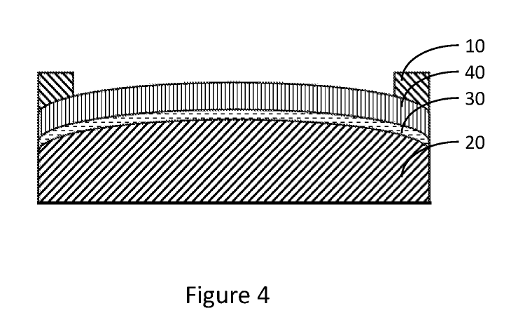

Referring to FIG. 4, the top surface of the supporting board 20 is not flat but curved outward. In a preferred embodiment of the present invention, the top surface is arched but the straight edge is parallel to the cylindrical lenses. Preferably, as the cylindrical lenses are aligned vertically, the vertical direction of the top surface is straight, the horizontal direction of the top surface is curved. In another embodiment, the top surface is convex.

The supporting board 20 and the frame 10 can be coupled together. In this situation, the image sheet 30 is pushed by the supporting board 20 to attach to the bottom side of the lenticular sheet 40. Since the top surface of the supporting board 20 is arched or convex, and the material of the lenticular sheet 40 is flexible, the supporting board 20 will cause the lenticular sheet 40 to deform along the curve of the top surface and generate a constant tensile force, which can press the image sheet 30 on the lenticular sheet 40 tightly without any gap in between.

It is worth mentioning, the curve of the lenticular sheet 40 is very small so it won't affect the 3D image and people won't observe any deformation.

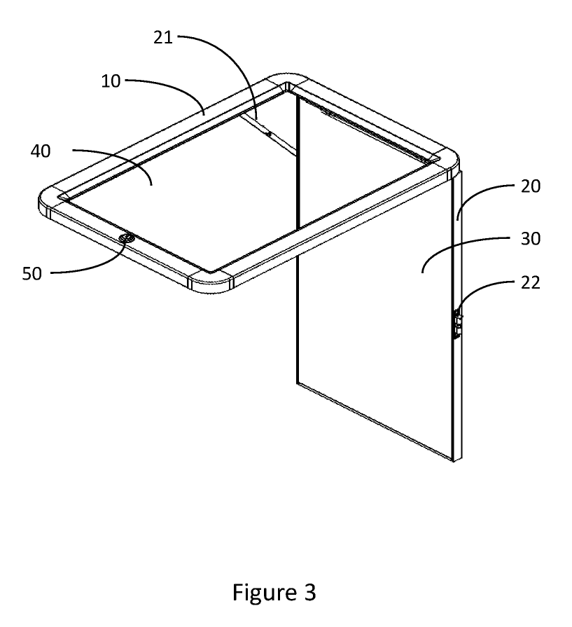

Referring to FIG. 3, in a preferred embodiment, the frame 10 and the supporting board 20 are hooked up by a hinge 11, so the frame 10 can be lifted around the hinge 11 to open the 3D display. The frame 10 and supporting board 20 are also connected by a foldable bracket 21. When the 3D display is hung on the wall, this foldable bracket 21 can hold the frame 10 in position when it is opened. This will save a hand to replace the image sheet 30.

The lenticular 3D display also comprises one or more fasteners 22 to fasten the frame 10 and the supporting board 20 when the 3D display is closed. The fastener 22 could be hook, screw, elastic latch, etc.

The lenticular 3D display also comprises a lock 50 to lock the frame 10 and the supporting board 20 together.

The lenticular 3D display may also comprises a light source. The light source may be placed in front of the lenticular sheet 40, such as inner edge of the frame 10; or behind of the supporting board 20 when the supporting board 20 is transparent. The light source could be LED, or fluorescent lamp.

Referring to FIG. 2, the supporting board 20 also comprises some hanging features to hang the 3D display on a wall. For example, a board with holes 23, and boards with sticker 24.

While the embodiments and alternatives of the invention have been shown and described, it will be apparent to one skilled in the art that various other changes and modifications can be made without departing from the spirit and scope of the invention.

What is claimed is:

1. A lenticular 3D display, comprising:
a frame;
a lenticular sheet having a top side and a bottom side received in the frame with the top side exposed, wherein the top side comprises an arrange of lenses with a set of predetermined characteristics, and the bottom side is flat;
an image sheet with lenticular image printed thereon, wherein the lenticular image is designed in accordance with the set of characteristics of the lenticular sheet for achieving a desired effect; and
a supporting board coupled with the frame, wherein comprises a top surface to removably hold the image sheet thereon and push the image sheet to attach to the bottom side of the lenticular sheet with no gap in between, wherein the top surface is curved outward.

2. The lenticular 3D display, as recited in claim 1, wherein the lenticular sheet comprises an arrange of cylindrical lenses aligned vertically.

3. The lenticular 3D display, as recited in claim 2, wherein the top surface of the supporting board is arched with the straight edge parallel to the cylindrical lenses.

4. The lenticular 3D display, as recited in claim 3, wherein the lenticular sheet received in the frame is replaceable.

5. The lenticular 3D display, as recited in claim 4, wherein the frame and the supporting board are hooked up with a hinge.

6. The lenticular 3D display, as recited in claim 5, wherein comprises one or more fastener to fasten the frame and the supporting board.

7. The lenticular 3D display, as recited in claim 6, wherein comprises a lock to lock the frame and the supporting board.

8. The lenticular 3D display, as recited in claim 7, wherein the supporting board comprises one or more clips to hold the image sheet.

9. The lenticular 3D display, as recited in claim 8, wherein the supporting board comprises protruded lines to align the image sheet.

10. The lenticular 3D display, as recited in claim 8, wherein the supporting board comprises a foldable bracket to support the frame when the frame is lifted from the supporting board.

11. The lenticular 3D display, as recited in claim 10, wherein comprises a light source in front of the lenticular sheet to light the front side of the lenticular sheet.

12. The lenticular 3D display, as recited in claim 10, wherein comprises a light source behind the supporting board, wherein the supporting board is transparent.
